(19) United States
(12) Patent Application Publication
(10) Pub. No.: US 2007/0034514 A1
(43) Pub. Date: Feb. 15, 2007

(54) Device for deionizing saline solutions

(75) Inventor: Michel Riera, Chatreauneuf De Grasse (FR)

Correspondence Address: DRINKER BIDDLE & REATH;ATTN: INTELLECTUAL PROPERTY GROUP, ONE LOGAN SQUARE, 18TH AND CHERRY STREETS, PHILADELPHIA, PA, 19103-6996, US

(73) Assignee: R Cube Projet, Chateauneuf De Grasse (FR)

(21) Appl. No.: 10/572,041

(22) PCT Filed: Sep. 23, 2004
(86) PCT No.: PCT/FR04/50456

§ 371 Date: Mar. 15, 2006

(30) Foreign Application Priority Data
Sep. 23, 2003 (FR) 03111128

(51) Int. Cl. B01D 61/42

(52) U.S. Cl. 204/627

(57) ABSTRACT

The invention relates to a device comprising a Laplace power generator acting on a deionizing cell provided with at least one deionizing cell comprising a first element provided with an alternate pile of membranes which are selectively ion-permeable and define concentrating chambers, deionizing chambers and a chamber on each end of the pile, a second element comprising a pile having a number of membranes equal to the first element but said membranes are electrically insulated and extend the chambers of the first element, and a third element provided with two chambers, one of them combining all concentrating chambers and end chambers, the other combining all deionizing chambers.

### FIELD OF THE INVENTION

The invention concerns one or more deionization device(s) traversed by an ionized solution comprising a cell with:
an envelope and
a deionization chamber and a concentration chamber, separated by ion-permeable membranes, the ionized solution circulating along the membranes and the at least partially deionized solvent, being collected on leaving the deionization chamber.

Water, although in inexhaustible supply on the planet since it undergoes a cycle of transformation, which is continually regenerating it, nevertheless becomes a precious element since its availability on land is highly variable and only pure fresh water, representing less than 2.5% of the total quantity of water in existence, is directly usable for consumption, agriculture and industry.

The problem of availability of fresh water is today experienced across the entire Mediterranean basin and estimates emphasize that the shortage of fresh water will affect half of humanity by 2020.

The salt water of oceans and seas, representing more than 97% of the total water stock, is not directly usable and numerous industrial developments are undertaken to desalinate seawater, brackish water and waste waters before they are flushed into the drains.

The political, economic and ecological stakes are extremely high.

### STATE OF THE ART

On the industrial level, there are two competing techniques: water distillation by means of evaporation/condensation leading to the construction of multiple-effect thermal power plants and of multi-flash thermal power plants, and membrane filtration.

Reasonably well harnessed, these thermodynamic principles remain major consumers of energy and their uses are reserved only for those geographic zones also exploiting petroleum resources. Some advances in the use of solar thermal energy deserve consideration but remain currently very marginal.

Membrane filtration under pressure gradient ranges from simple filtration to reverse osmosis, via nanofiltration. Using less energy than thermal centers, these filtration techniques are increasingly competing with them. The progress made on membranes leads one to suppose that membrane filtration will supplant evaporation condensation. The major physical problem of membrane techniques is that of osmotic pressure, which must be overcome in order to carry out the filtration. This pressure, proportional to the dissolved salt concentration, is significant for seawater. Generally 75 kg/cm of pressure is used in small desalination units. The creation of these high pressures is energy-consuming and poses serious problems of membrane resistance at such a pressure gradient.

Membrane filtration may also be carried out under electric voltage gradient: this is known as electrodialysis. The dissolved salts in seawater, brackish or wastewater are predominantly in the form of ions. The alternation of cationic membranes (permeable only by cations) and anionic membranes (permeable only by anions) separated by small dividers defining the space between membranes, constitutes an electrodialysis cell. Electrodes, placed on either side of the cell, and plunged into the solution to be deionized, create the electrical field necessary to make the ions move through the membranes and which leads to the deionization of one in every two chambers and the increase of salt in the others.

Easy to implement, electrodialysis has many applications for the recuperation of ions in industrial wastewater and the desalination of brackish water with a concentration below 3000 ppm.

Since the salinity of seawater is higher than 20,000 ppm, electrodialysis is not applicable without high maintenance due to the corrosion of the electrodes and the blocking of membranes where electrochemical reactions take place under high electrical currents.

The working principle of a known electrodialysis cell will be described hereinafter using FIG. 1 and an application of this principle will be described using FIG. 2.

According to FIG. 1, an electrodialysis cell is made up of three chambers: a chamber containing the cathode 1, a chamber containing the anode 2, and between the two, a chamber delimited on the cathode side by a cationic membrane 3 (permeable by cations) and on the anode side, by an anionic membrane 4 (permeable by anions).

To increase the efficiency, multiple chambers formed by the alternation of cationic and anionic membranes and ending on one side in the chamber containing the cathode, and on the other side the chamber containing the anode. This configuration creates deionization chambers 5, concentration chambers 6, a cathode chamber 1 where cathodic electrochemical reactions take place, and an anode chamber 2 where anodic electrochemical reactions take place. There is no communication between these compartments except for at the entry point of the solution to be deionized, where all compartments are supplied in parallel with the ionic solution.

This conventional electrodialysis cell uses only the electric component of the Lorentz equation. The cathode and the anode immersed in the cathodic and anodic chambers respectively, brought to a potential difference U, create an electric field E=dU/dx, which allows the migration of cations towards the cathode and of anions towards the anode FIG. 1, FIG. 2. The cathode gives up electrons to neutralize the cations, which either are released in the form of a gas or react with the solvent. The anode attracts the excess electrons from the anions, which either emanate in the form of a gas or react with the solvent. These are the electrochemical reactions of the electrodes, which polarize and corrode in these reactions.

The electrical circuit is closed. It is constituted of a generator maintaining the potential difference between the electrodes and producing current in the charge resistance constituted by the electrodialysis cell. The selectively ion-permeable membranes act as capacitors having a bleed resistance and the ionized fluid in the concentration and deionization chambers act as pure resistances. The capacitors composed of the membranes are charged by the establishment of the voltage and maintain this charge, while the current circulating and in balance is due only to their resistance. These surface charges constitute a diffusion barrier, reducing the bleed currents (selective diffusion of ions in the membrane), and are responsible for the precipitation of certain salts, thus clogging the membranes.

At the exit, the deionization chambers are linked together to provide deionized solvent; the concentration chambers are linked together to give a concentrated solution, and the anode and cathode chambers are generally kept separate to recuperate the bases or acids developed there by electrochemical reaction on the electrodes.

In the field of deionization of saline solutions, the documents DE 1 811 114 of 1970, DE 3 031 673 of 1982, DE 3 521 109 of 1986 and WO 03/048050 of 2003 use fixed magnetic fields, generated by permanent magnets or electromagnets fed by continuous current, or mobile magnetic fields by mechanically moving the permanent magnets or the electromagnets in relation to the solution to be deionized.

The magnetic part alone of the Lorentz equation is considered: F=q*(v×B). The force (F), generated on the electric charge (q) of the opposite sign traveling at a relative velocity (v) across a magnetic field (B), separates the electric charges of the opposite sign, which generates an electric field E whose representative vector is equal and opposite to the representative vector of the vector product v×B.

The separation of the electric charges then ceases.

The electric field E thus created derives from an electric potential U such as dU/dx=E.

This electric potential characterizes the Hall effect: (dU/dx=−v×B), or E+v×B=0, and becomes a steady state condition if v and B are constant. F=0 and the electric charges are no longer diverted from their normal trajectory.

The Laplace force, of solely magnetic origin, applied in deionization of a duct of an ionized fluid in movement relative to the magnetic field, creates an electric potential difference U between the opposite walls of the fluid duct, parallel to the plane defined by vectors v and B. The fluid duct can thus be considered as being a charged capacitor whose electric charge Q has a value of C*U, C being the apparent capacitance of the capacitor. This charge Q, expressed in coulombs, is a surface charge distributed according to the laws of electrostatics on the internal surfaces of the tube or any section thereof, delimiting the duct.

Knowing that a faraday, or 96490 coulombs, is required to remove one gram-equivalent of electrolyte from a solution and that a coulomb is the charge of a capacitor when C has a value of one farad and U of one volt, the charge Q, generated by the magnetic component of the Laplace force for purposes of deionization, is very small, in the order of several millionths of a coulomb in most cases, and cannot by itself hope to carry out an extraction of dissolved salts.

The problem then becomes one of suppressing the Hall effect, that is, of the electric field generated by the separation of the charges subjected to the Laplace force in order for the separation to take place.

The abovementioned documents merely reject the sections, of the ionized fluid duct, circulating in a laminar manner along electrically charged walls, as if the charge were volumic. The American patent conceives of three porous virtual walls in order to avoid the delimitation of the fluid duct and the appearance of the Hall effect. By eliminating thus the principal datum of the problem, the American patent offers no solution to it. Its proposals are presented as theoretical responses to a problem that is not posed. The other proposed solutions amount to discharging the walls using immersed electrodes creating an electrophoresis or using the electric potential of the Hall effect as an electric generator. A classical electrolysis, not considered in the American patent, is then produced with the phenomena of electrode polarization and corrosion.

### AIM OF THE INVENTION

The present invention aims to develop an electrodialysis process and installation remedying the disadvantages of the known processes and installations and, notably, the corrosion of the electrodes and the clogging of the membranes, where the electrochemical reactions induced by the large electric currents take place, in such a way as to allow continuous operation over prolonged periods without the need for intervention on the installations. It also aims to propose inexpensive solutions in technical achievements, consuming the minimum necessary energy to deionize an ionized fluid.

### DESCRIPTION OF THE INVENTION

To this effect, the invention concerns a deionization device for saline solutions of a type defined below characterised in that it contains at least one deionization cell constituting a continuous conduit whose exterior wall is totally impermeable to fluid, electrically insulating and non-ferromagnetic, each cell comprising:
a first element provided with an alternate pile of membranes, which are selectively ion-permeable, separated by dividers defining concentrating chambers, deionizing chambers, and a chamber at each end of the pile,
a second element comprising a pile having a number of membranes equal to the first element but electrically insulating and separated by dividers extending the deionizing chambers, the concentrating chambers and the end chambers of the first element,
the third element provided with only two chambers, one of them combining all concentrating chambers and end chambers, the other combining all deionizing chambers.

The deionizing device according to the invention avoids all problems of electrode corrosion and clogging of the membranes and allows continuous operation of the device, without the need for periodic intervention. The whole of the installation functions simply and it is particularly effective for multiple applications such as the production of freshwater from seawater, the softening of hard water, the treatment of wastewater, the recuperation of toxic or precious metal ions and the production of ultra-pure water for industry.

In general, the deionizing device is applicable to any ionized fluid, liquid or gaseous.

To date, for technical reasons in the manufacturing of electrodes, electrodialysis cells have a structure with a rectangular cross-section. Solving this electrode problem permits the conception of differently-shaped cells, easily producible industrially.

Following another characteristic, the device comprises a succession of cells and the fluid at least partly deionized by the cell is then injected into the deionizing chambers of the first element of the next cell, the concentrated fluid being injected into the concentrating chambers and the end chambers of the first element of the next cell.

According to one embodiment mode, the Laplace force only acts on the first two elements of a deionizing cell, developing on the ions of the fluid, a force not parallel to the plane of the selectively ion-permeable membranes and the electrically insulating membranes and oriented in such a way that the cations traverse the selectively cation-permeable membranes and the anions traverse the selectively anion-permeable membranes, the vectors being in the same direction.

In this case,
the two first elements of each deionizing cell have a helicoidal form,
the Laplace force is generated with a zero electric field, the high relative velocity of a mobile magnetic induction rotating around the axis of the helicoidal form in relation to the ions of the ionized fluid circulating slowly, the displacement of the magnetic induction resulting from the vectoral combination of alternate dephased inductions of the same frequency whose respective dephasings and orientations in a spatial plane give an induction rotating in a single direction at the frequency in this plane,
the Laplace force generator is external to the cell.

Following another interesting characteristic, the Laplace force applied to the cell is produced with a magnetic induction of zero, the electric field is generated by two electric conductors, external to the cell, raised periodically to a potential difference, constant during one part of the period and zero during the other, giving a signal in the form of square-wave crenels, the electric field being oriented so that the force acting on the ions causes the cations to pass through the selectively cation-permeable membranes and the anions to pass through the selectively anion-permeable membranes, the Laplace force generator being external to the cell.

According to another characteristic:
the third element of each cell possesses four distinct chambers,
a concentrating chamber combining all the concentrating chambers of the second element,
a deionizing chamber combining all the deionizing chambers of the second element,
the end chambers, one of which contains fluid with an excess of cations, the other of which contains fluid with an excess of anions, being retrieved and treated separately,
the end chambers of the first element of the next cell receiving initial ionized fluid or concentrated fluid produced by the preceding cell.

In this case, the end chambers, one of which contains an excess of cations, the other of which contains an excess of anions, are placed in electric relation via electrodes in contact with these fluids, thereby developing an electric voltage that can be used to generate electricity and providing the recoverable products of electrolysis corresponding to the ionized fluid used.

Following another advantageous embodiment,
a cell having an external wall totally impermeable to fluid, electrically insulating and non-ferromagnetic, deionizing chambers alternating with concentrating chambers compartmentalized by selectively ion-permeable membranes and likewise alternated, separated by dividers defining the chambers, and an external induction generator rotating within the plane of the membranes, acting on the whole length of the cell by producing a force on the ions of the ionized fluid circulating, at velocity, so that the cations pass through the cation-permeable membranes and the anions pass through the anion-permeable membranes, thereby developing a Hall effect potential on the internal wall of the end chambers of the cell,
the cell being formed of a helicoidal coil placing one wall carrying one type of ions and another wall carrying the other type of ions in electric contact, by means of an electroconductive junction, the walls themselves being locally conductive along the length of this junction established along the whole length of the helicoidal coil in order to continually discharge the Hall potential,
the useful length of the first element of the cell is thus large relative to its second and third elements, the time constant being infinite.

In this manner, the fluid, progressively enriched in the products of electrolysis in the end chambers of the cell, is recovered in places along the cell's length when the concentration makes it necessary, and it is replaced by initial ionized fluid or concentrated fluid derived from the concentrating chambers upstream of the collection points.

According to another interesting embodiment,
the end chambers contain electrodes in contact with the ionized fluid, the electric field is generated by two electric conductors internal to the cell, the cathode being in the chamber enclosed by the external wall and a selectively cation-permeable membrane, and the anode in the chamber enclosed by the external wall and a selectively anion-permeable membrane,
the electrodes are fed by a periodic electric voltage in the form of a squared signal, constant during one part of the period and zero for the other part,
the useful length of the first element of the cell is thus large relative to its second and third elements, the time constant being infinite.

In the elements below,

the deionized fluid recovered at the exit the deionization conduit is treated with reverse osmosis, but at low pressures, in order to eliminate those non-ionic substances that may equally be present in the ionized fluid used and to provide an ultra-pure fluid.

According to another characteristic, the deionization cell is an element whose length is formed of at least three tubes encased one inside the other, with parallel axes, whose walls are composed of non-ferromagnetic substances, the wall of the external tube being impermeable to the fluid to be deionized and electrically insulating, and that of the internal tubes constituting two opposing portions following a plane passing through the axis of the internal tube, in a semi-ion-permeable substance, one being cation-permeable, the other anion-permeable, these two portions of the wall being connected and the structure of the two internal tubes being reversed.

According to another advantageous characteristic, the electric field of the Laplace force generator is generated by the plates of a capacitor placed outside the cell.

It is interesting from the constructive point of view that the capacitor should be formed by a metallic film deposited in two lateral and diametrically opposed bands on the cell wall, each band being connected to a pole of a generator of continuous electric voltage.

The invention likewise allows the procurement of acids and bases corresponding to the ions present in the solution to be deionized. For this purpose, the deionizing cell is additionally provided with two isolated end chambers without direct communication with the others, one closed by a membrane permeable only to cations, the other by a membrane permeable only to anions, each solution enriched in a type of ions being recovered separately upon exiting the deionizing cell.

According to another advantageous characteristic, upon exiting the deionizing cell, the electrodes are placed in contact with the base and acid solutions thereby allowing the recovery on the one hand of the electric energy produced by the electrochemical potential difference of the solutions and on the other hand of the products resulting from the electrolysis induced by the electrochemical reactions at the electrodes.

It is interesting to augment the efficiency of the device by means of a deionizing cell of spiral helicoidal shape, placing the cationic and the anionic chambers in proximity to one another and linking tern by means of an electrically conductive junction.

Finally, from the point of view of the realization of the cell, it is particularly interesting to form the deionizing cell by means of an element of length formed by at least three tubes encased one inside the other, with parallel axes, whose walls are of a non-ferromagnetic substance, the wall of the external tube being impermeable to the solvent of the solution to be deionized and electrically insulating, the wall of the internal tubes constituting two opposing parts following a plane, notably vertical, passing through the axis of the internal tube, in an ion-permeable substance, one cation-permeable and the other anion-permeable, these two portions of the wall being linked directly or by portions of wall in an impermeable substance, the two internal tubes being reversed in structure in terms of the plane.

### DRAWINGS

The present invention of a deionizing device shall be described hereinafter in a more detailed manner using the embodiment modes represented in the annexed drawings in which:

FIG. 1 is a simplified schema of the principle of a deionizing cell according to the state of the art,

FIG. 2 shows a development of a deionizing cell according to the state of the art,

FIG. 3 shows in a schematic manner a deionizing cell implementing the process of the invention,

FIG. 4A shows schematically a cross-section of a cell of a deionizing device according to the invention, the fluid circulating perpendicular to the plane of the figure,

FIG. 4B shows the equivalent electric schema of the cell in FIG. 4A,

FIG. 5A is a view of a deionizing cell, the direction of transit of the ionized fluid being parallel to the plane of FIG. 5A, FIG. 5B is a cross-section according to the line of FIG. 5A,

FIG. 6 is an equivalent schema of a deionizing cell according to FIG. 5A for its three constituent elements T1, T2, T3 as well as a succession of two deionizing cells,

FIG. 7 is a schema of another embodiment mode of a deionizing cell with helicoidal travel of the ionized fluid,

FIG. 8 is a schematic cross-section to a different scale of three turns of a deionizing cell according to FIG. 7,

FIG. 9 shows another embodiment mode of a deionizing cell using an electric field creating the Laplace force,

FIG. 10 is another view of the deionization cell of FIG. 9 showing the succession of the elements and in the upper part of the figure, the command voltage U(t) of the cell,

FIG. 11 is a schema equivalent to the cell of FIG. 10,

FIG. 12 shows another embodiment mode of a deionizing cell with immersed electrodes,

FIG. 13 shows different chronograms of the command voltage of the cell in FIG. 12 and of the charge current,

FIG. 14 is a diagram of the devolution of concentrations in the diluate of an electrodialysis cell according to the invention.

### DESCRIPTION OF THE EMBODIMENT MODES OF THE INVENTION

FIG. 3 shows the functional flow diagram of a cell of a deionizing device or a device being an element of a combination of cells in series and/or in parallel and implementing the process of the invention.

The cell, presented in cross-section, is traversed by the liquid to be deionized, circulating in a direction perpendicular to the plane of FIG. 3.

The liquid traverses the cell following a velocity V perpendicular to the plane of FIG. 3.

A deionizing cell is constituted overall of three composite tubes encased one inside the other with parallel or coaxial axes, of any cross-section, whose walls are of a non-ferromagnetic substance. This cross-section, nevertheless preferably in a perceptibly circular shape, is symmetrical in relation to a direction conventionally chosen as the vertical direction represented by the plane PV. The cell comprises an exterior envelope, impermeable to the ionized fluid to be treated and electrically insulating. This exterior envelope extends into the interior by means of two impermeable partition pieces, situated in the plane PV. These partition pieces join onto the interior tube formed by a cationic partition 3 and an anionic partition 4 surrounding the concentrating chamber 6. Between the exterior wall and the concentrating chamber, there is a cationic membrane 3 and an anionic membrane 4 delimiting on each side the deionizing chamber 5, here in two parts. In fact, these two parts of the deionizing chamber are linked by passages in the impermeable partition pieces in the plane PV.

This structure corresponds to a very simple technical embodiment of a deionizing cell. According to the embodiments, the dimensions of the cross-section of the internal and external tubes can vary from a few microns to centimeters. Such a cell may thus be linear, folded on itself, or have a helicoidal or spiral structure. Thus constituted, the deionizing cell is a conduit placed in at least one magnetic or electric field or both simultaneously.

The Laplace force is perpendicular to the plane PV. The electric field is perpendicular to the plan PV and its vector is contained in the plane of FIG. 3. The magnetic field B is parallel to the plane PV and perpendicular to the velocity vector V; it is contained in the plane of FIG. 3.

Under these conditions, the ions are subjected to a force resulting from the application of the electric field E and of the magnetic field B combined with the velocity V of the liquid following the Lorentz relationship:
F=q*(E+v×B)
F=Laplace force
q=electric charge of an ion
E=electric field
V=velocity relative to the charge in relation to the magnetic field B
B=magnetic field.

The magnitudes F, E, V, B are vectors, the operator *, the scalar product, and the operator × that of the vector product.

According to the application, the electric field E is chosen from within a range between a zero value and a maximal value. The magnetic field B may be zero or have a fixed or variable value.

The velocity V of the liquid is, in principal, not zero. In fact, the velocity of the liquid is a relative velocity in relation to the magnetic field.

Given the orientation selected for the electric field E and that of the magnetic field B, the Laplace force F is perpendicular to the surface of the membranes. The sign of the vector force F depends on the electric charge. This force is opposite for positive or negative ions of the same charge, found under the same conditions in the cell.

The migration of the (+) and (−) charges, which represent the ions in FIG. 3 takes place through the membranes 3, 4, as indicated by the arrows.

The positive and negative ions exit the deionizing chamber 5 through the walls 3, 4 respectively, arriving in the cationic and anionic chambers. They also pass through the membranes 3 and 4 of the internal tube, arriving in the concentrating chamber 6.

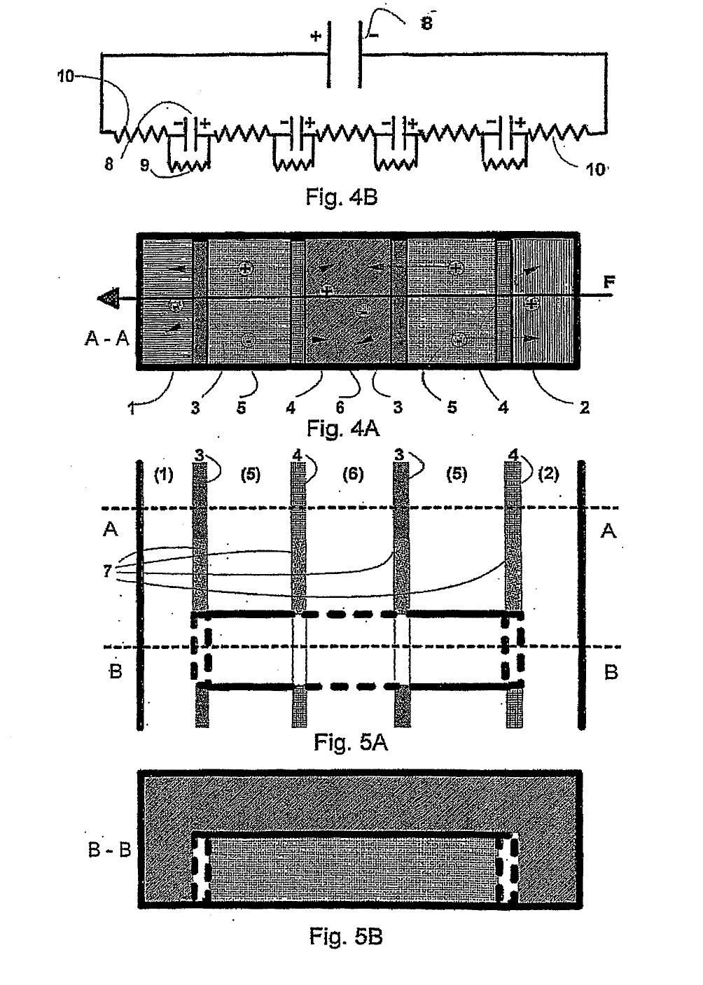

The electric field applied to the deionization cell is supplied by a capacitor with two plates applied against the sides of the cell. The electrodes that apply the electric field are placed outside compartments 1 and 2 without being in contact with the liquid. The magnetic field B is produced either by a permanent magnet applied on the upper or lower part or two magnets placed on each of the two faces respectively. This field may also be produced by an electromagnet. The field is fixed or of variable intensity but with a given direction corresponding to arrow F in FIG. 3 or 4.

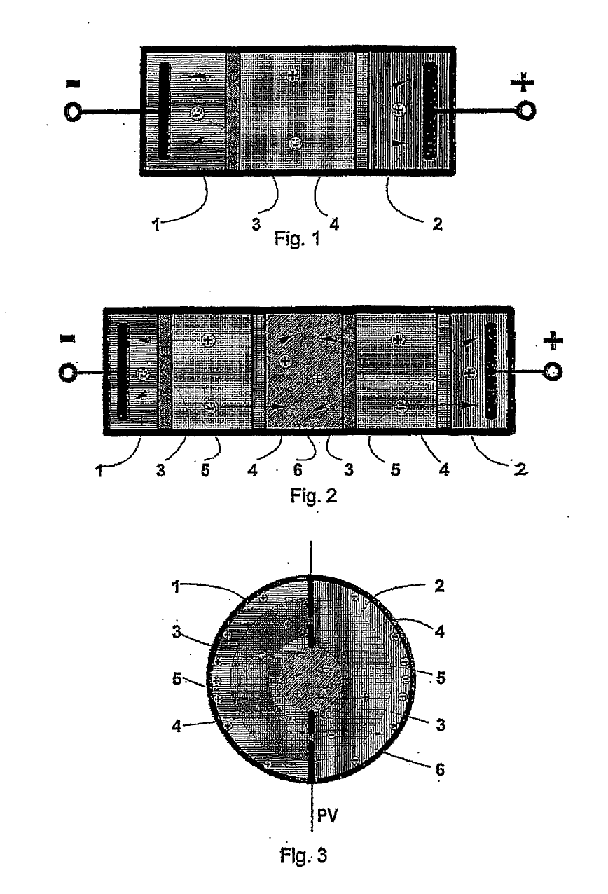

In contrast to the cell in FIG. 1 or 2, the embodiment of the cell according to the invention eliminates the electrodes from the anodic and cationic chambers and links all the deionizing chambers 5, as well as all the concentrating chambers 6, in the case of a succession of ion-permeable walls 3, 4, in order to achieve a large permeable surface.

A length of this cell (in the direction perpendicular to the sheet of FIG. 3 or 4) determined by practical considerations of technical realization, constitutes a deionizing cell. Upon entry to the cell all chambers are fed in parallel with the solution to be deionized. Upon exiting the cell, the deionized solution is recovered, having circulated around the interlinked deionizing chambers, as is the concentrated solution, having circulated around the interlinked concentrating chambers; the anodic and cationic chambers are also reunified with the concentrating chambers.

Having considered the duct of ionized fluid, whose ions are subjected to the Laplace force, as becoming a charged capacitor, the invention considers the transitory aspect of the capacitor charge.

If Q(t) is the charge developing on the surface of the opposing walls of the fluid duct, C the capacitance of said fluid duct, R its electric resistance following a line of current representing the movement of the ions subjected to the Laplace force as well as to the motion of the fluid and U the electric potential generated by the Hall effect, the laws of electrokinetics give:
Q(t)=C.U.(1-exp(−t/RC)) and I(t)=dQ/dt=(U/R).exp(−t/RC).

The product RC=τ characterizes the time constant of the phenomenon of the appearance of the Hall effect: U=constant, Q=CU and I=0.

At the end of a time t=6.9.(RC) the current I has only 1/1000 of its initial value U/R. Given that the higher the ionic concentration of an ionized liquid, the smaller its resistivity, and that the apparent capacitance of an element of the fluid duct is also very small, for a fluid duct model with a rectangular cross-section a capacitance element is represented by dC=ε.dS/x, (ε) being the apparent dielectric constant of the ionized fluid, dS a surface element of the opposing walls of the fluid duct and accumulating the surface charges, (x) the distance between these walls and characterising one of the two dimensions of the rectangular cross-section of the fluid duct. The value (x) cannot therefore become too small in order to conserve a flow for the fluid duct. As a result the time constant RC is very small, in the order of only a few microseconds.

This consideration determines the useful length of the fluid duct, in the direction of relative movement of the ionized fluid in relation to the magnetic induction. If v is this relative velocity, the useful length of the duct where an ionic current exists in order to develop the Hall effect is only v.τ; the time constant τ=RC being very small, it follows that (v) must be very large to give a technically realizable fluid duct length. The speed of the fluid in the duct being generally low, less than several meters per second, it follows that the magnetic field must move very fast. This speed must be very high, RC=τ being in the order of 10⁻⁶ seconds.

According to the invention, the magnetic field is set in motion without any mobile parts by using the rotating magnetic field resulting from the vectoral combination of alternating magnetic fields analogous to those produced by the electromagnets constituting the stator of an asynchronous motor fed by di-, tri- or polyphasic current.

The angular rotation velocity of this rotating induction is given by ω=2πf, f being the frequency of the polyphasic current. At a distance d from the centre of rotation of this induction, the tangential velocity is given by v=d.ω. For d=1 centimeter, and f=50 hertz the tangential velocity is already greater than 3 m/s. For f=500,000 Hz, this velocity becomes 30,000 m/s. The technical problem remaining to be resolved is that of losses through the hysteresis of the ferromagnetic substance used to create the inductors. Soft ferrites have low hysteresis and are suitable for use at high frequencies.

In this manner, the rapidly rotating magnetic field may reach the velocity v necessary to have a technically realizable useful length of fluid duct.

In order to “discharge” the Hall potential created on the useful portion of the duct, consider the real movement of the ions in the ionized fluid duct subjected to a Laplace force.

The study of the mechanisms of electrolysis shows that the ion mobility is low, in the order of several microns per second in an electric field in the order of 100 volts per meter. Even if the speed of the fluid in the duct is relatively slow, several centimeters per second, the ions follow a slightly deviating trajectory relative to the duct axis. During the time τ=RC, where the transverse current of the Hall effect exists and the fluid actually possesses volumic charges close to the duct walls, these charges create, because of the constituent of their movement parallel to the duct axis, a current parallel to the latter and whose intensity decreases contingent on the disappearance of the volumic charges.

FIG. 4A shows a cell and FIG. 4B shows its modeling by means of the elements of the electric circuit.

The ionized fluid duct subjected to a transverse Laplace force is the equivalent of a capacitor 8. If (ρ) is the resistivity of the ionized fluid and (ε) is its dielectric constant, the electric resistance may be calculated, likewise the capacitance of an element of length of the fluid duct of a given section.

In an electrodialysis cell composed of alternating piles of cation-permeable and anion-permeable membranes, spaced out by separators defining the chambers and if (ρm) is the resistivity and (em) is the dielectric constant of the constituent material of the membranes, taken identically for both types of membrane for reasons of simplicity, a membrane becomes the equivalent of a capacitor having a bleed resistance, 9.

Modeled in this manner, an element of length of the duct of ionized fluid circulating in an electrodialysis cell, without immersed electrodes in the cathodic and anodic side chambers, may be seen as the series connection of resistors and capacitors having bleed resistances. The electrodialysis cell is entirely delimited by a completely fluid-impermeable wall, electrically insulating and of course non-ferromagnetic in order to allow the passage of the magnetic field.

Under the action of the Laplace force transverse to the fluid duct, the ions acquire a transverse motion component. A current runs through the circuit consisting of capacitors, with bleed resistances, and resistors in series 10, and generates charges of opposite sign on the opposing lateral faces of the fluid duct until the electric field generated by these charges opposes the transverse movement of the ions. The section length of the duct under consideration is thus a charged capacitor. The volumic charge no longer exists between the charged walls of the capacitor. The capacitors representing the membranes are temporarily charged during the circulation of the current allowing either the cations to pass through the cation-permeable membranes, or the anions to pass through the anion-permeable membranes, which characterizes their bleed resistance. The surface charges of the membranes, created during the circulation of the current, disappear as a result of this bleed resistance once the transverse ionic current stops.

FIG. 5A is a schematic view of a deionizing device whose first element, cut away along line AA of FIG. 5, is represented in FIG. 4A; FIG. 5B is a cut-away view according to BB of FIG. 5A.

As the useful length of the fluid duct, subjected to a transverse Laplace force, is v.τ, the selectively ion-permeable membranes play no further role after this length and may therefore be replaced by perfectly insulating membranes without bleed current 7.

The invention therefore considers two phenomena:
Firstly, a side-effect. At the level of the transition between the selectively ion-permeable membranes and the perfectly insulating membranes, if said transition takes place before the end of the useful length of the fluid duct, the still-volumic charges retain their longitudinal component in the direction of the fluid motion and are deposited on the internal surface of the duct wall beyond the transition line. Consequently the density of the surface charges on the internal wall of the fluid duct is not homogenous and the greater the speed of the fluid circulation, the more important will be this side-effect. Furthermore, the perfectly insulating membranes have a dielectric constant (εi) different from that of the selectively ion-permeable membranes. Consequently the capacitance of a duct element containing the insulating membranes varies in (dC). The voltage U characterising the Hall effect being constant, consequently the surface charges of the walls of the ionized fluid duct, as well as the surfaces of the insulating membranes acquire, on this portion, an excess charge dQ such as dQ=dC.U.
Secondly, the charged wall is directly in contact with the ionized fluid, the latter being an electric conductor having a certain resistance. The electric potential following a generator parallel to the axis of the ionized fluid duct is constant. If this were not the case, an electric field E1 would exist, tangential to this generator, such as E1=dU(1)/(d1) and would produce a surface electric current tending to discharge this surface potential difference.

For the following portion of the ionized fluid duct, the Laplace force acting up to this point is suppressed. The insulating membranes discharge their charges dQ through the resistance constituted by the inter-membrane ionized fluid, the end chambers, cathodic and anodic, without electrodes, see the variation of the charge dQ cancel itself out in the same manner, and the principal charge Q change surface, under the action of the electric field E′ that they themselves create, and which is not compensated for by a field of external origin. These chambers possess, on the surface of the insulating wall, the charge displaced by the Laplace force in the first section.

It is therefore sufficient to interlink these two chambers with the concentrating chambers in order to dissipate the electric charges (FIG. 5B).

This means discharging the capacitor, which was formed by the ionized fluid duct subjected to the Laplace force, through the ionized fluid, more highly concentrated and thus with lower resistance. The time constant of this discharge is different from that of the charge, R and C having changed at this level. The charges dissipate at this level, the electric potential of the surface of the resistive conductor, formed by the ionized fluid duct, becomes zero. A surface potential gradient exists on the generator parallel to the axis of the fluid duct and consequently a surface electric field tangential to this generator: E(1)=dU(1)/d1 producing an electric current in the direction of motion of the ionized fluid.

The discharging of the Hall effect within the framework of a perfectly physically delimited fluid duct is ensured by the succession of three structures constituting an electrodialysis cell without electrode and the suppression of the Laplace force in the third structure.

The pursuit of deionization is carried out by means of injecting the concentrated ionized fluid, electrically neutral, into the concentration, cathodic and anodic chambers of a cell following the identical structure, the partially deionized fluid being injected into the deionizing chambers.

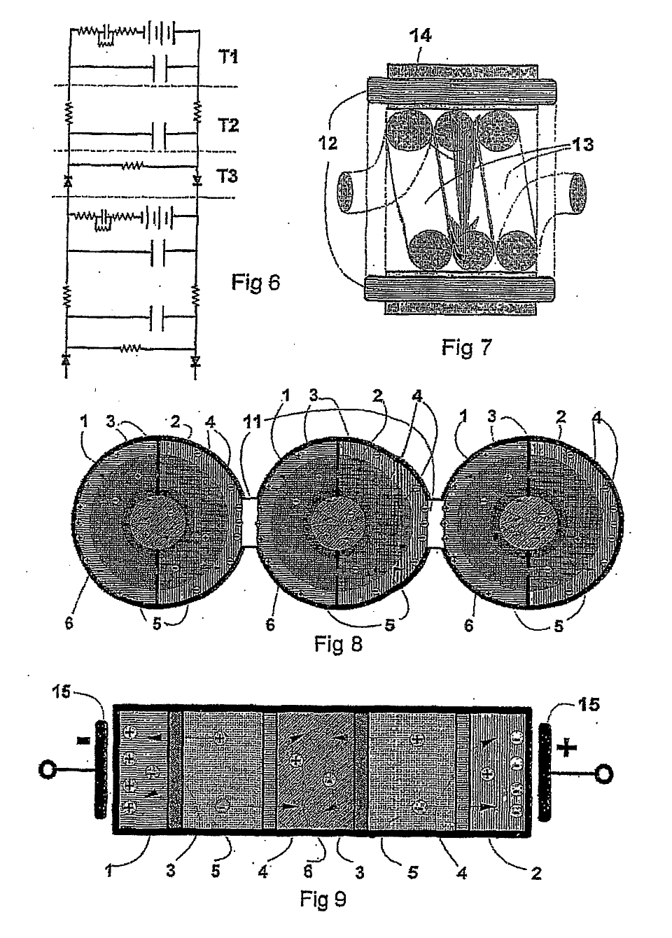

The whole of this structure according to FIG. 5A composed of the succession of three elements forming a deionizing cell is modeled with electric components (FIG. 6). In order to avoid overloading the schema of FIG. 6, the circuit components are represented by their habitual symbols without designating them through specific references.

The first unit T1 modeling the first element of the cell corresponds to a voltage generator supplying the plates of a capacitor through a charge impedance composed of resistors and capacitors with bleed resistance in series.

The second unit T2 modeling the second element of the cell corresponds to a capacitor without bleed resistance whose plates are linked to those of the preceding capacitor by resistors.

The third unit T3 modeling the third element of the cell corresponds to a charge resistor into which feeds the electric generator composing the first unit.

The following identical cell is linked by diodes (as the ionized fluid transporting the charges only flows in one direction) to the preceding cell. The downstream cell does not act electrically on the upstream cell. The current circulates permanently within the circuit of each following cell according to Kirchoff's laws. The capacitors, with or without bleed resistance, are only useful in considering transitory regimes (application, suppression of Laplace force).

FIG. 7 shows schematically a deionizing device in helicoidal shape and FIG. 8, a cut-away of such a helicoidal structure. In fact, the suppression of the Laplace force in a periodic manner within the space is designed with a rotating induction generator (FIG. 7) 14 equivalent to a stator 12 of an asynchronous motor 12. The ionized fluid duct in helicoidal shape 13 in its first and second sections is placed within the stator. The third section, helicoidal or otherwise, is external to the stator.

The useful length of the first section is physically conditioned by I=v.τ. This useful length I allows the diameter of the stator, its thickness and the frequency of the current to supply it to be determined.

This helicoidal structure of the ionized fluid duct subjected to a rotating induction leads the invention to consider another aspect of the problem of suppression of the Hall potential.

As in the helicoidal structure, the external wall of the chamber accumulating the cations may be found adjacent to the external wall of the chamber accumulating the anions, these two walls, possessing the Hall potential difference, are linked by an electroconducting junction 11 traversing the walls in order to come into contact with the fluid 11 (FIG. 8) in order to neutralize this potential difference.

The cations and anions exchange their electric charges via the conducting junction and transform into gas or react with the fluid. It is then interesting to recover, periodically along the length of the duct, the products of these electrochemical reactions for the particular interest they may represent, and to replace them by initial ionized fluid or concentrated fluid produced upstream in order to continue the deionization and concentration in the other chambers.

In this case, only the first element of the cell is used along the entire length of the fluid duct, the second and third elements being only cell ends, and the time constant τ no longer exists since the capacitor never reaches its full charge. Periodic repression of the Laplace force is no longer required and the rotating induction acts on the whole length of the first element of the duct.

This helicoidal cell shape subjected to the action of a rotating induction may be electrically modeled as an electric generator supplying current into the resistor composed of the conducting junctions 11. The resistance of these junctions being weak compared to the internal resistance of the generation (here the electrodialysis cell), the generator functions in short-circuit.

The optimization of this short-circuit current determines all the characteristics of the device: intensity of the rotating induction B, rotation speed f in number of rotations per second, diameter of the turn d, dimensions of the duct section, length of the duct.

FIG. 9 is a schematic cut-away view of another electrodialysis device according to the invention, now using the electric component of the Lorentz equation: F=q*E.

In order to reduce these membrane clogging problems, certain electrodialysis devices periodically reverse the direction of the current.

The invention offers a different solution.

Since the electric field causes the ions to migrate and allows their concentration in the concentrating chambers and their elimination from the deionizing chambers constituting the electrodialysis cell, this electric field is generated by a capacitor whose plates 15 are situated on either side of the cell and external to the same (FIG. 9).

As previously reported, during the establishment of a potential difference between the plates and the capacitor, an electric field traverses the electrodialysis cell, which is only an insulated conductor having an electric resistance, and produces a temporary current in the form: I(t)=(U/R).exp(−t/RC), which creates a charge Q(t)=C.U.(1-exp(−t/RC)) on the extremities of the conductor, facing the plates of the external capacitor. The electric field given by this distribution of charges to the extremities of the conductor is equal and opposite to the electric field created by the external capacitor. The current stops, and the capacitors corresponding to the membranes discharge due to their bleed resistance.

The system is therefore identical to that previously reported and using the magnetic component (v×B) of the Lorentz equation as a generator of Laplace force on a charge q.

It is a question of discharging the extremities of the conductor in order that a current may circulate again within this electrodeless electrodialysis cell.

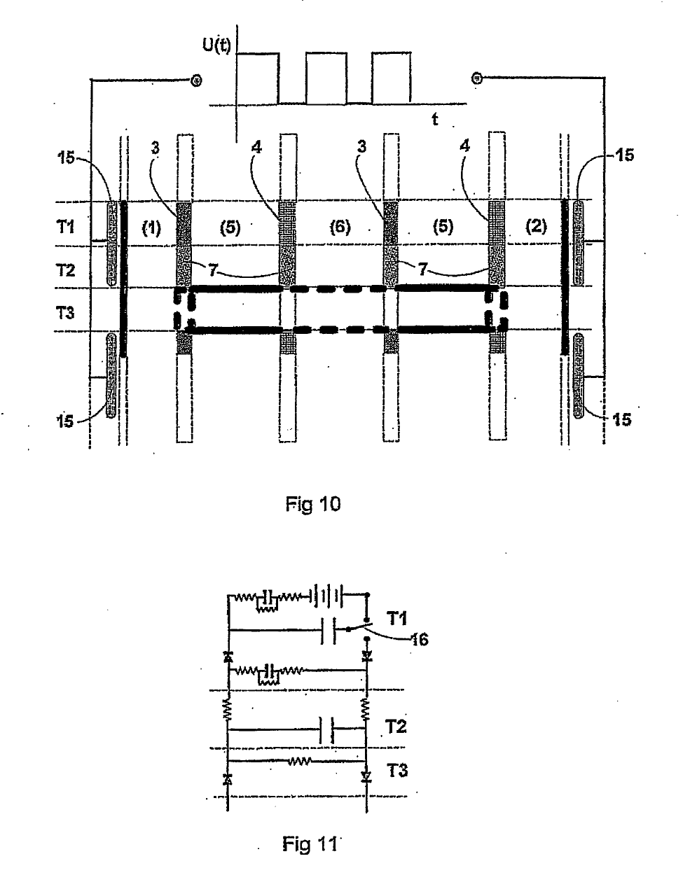

The technical solution represented in FIG. 10 uses the same references as above to designate the same means or equivalent means. The electrodialysis cell is composed of three successive elements or sections T1, T2, T3; the first element T1 has selectively ion-permeable membranes 3, 4, the second element T2 has perfectly insulating membranes 7, and the third element T3 connects the concentrating chambers and the end chambers possessing cationic and anionic charges. Only the first two elements T1, T2 are situated between the plates 15 of an external capacitor. The concentrated fluid is subsequently injected into the concentrating, anodic and cathodic chambers of a following cell which is not represented.

The electric modeling nevertheless poses a problem here. The resistive conductor, which models the electrodialysis cell, returns to a constant potential when the charge at its extremities is terminated. This was not the case when the magnetic component of the Lorentz equation was used, which permits the appearance of the Hall potential.

1) Principle

According to the invention, a periodic charge of square wave voltage of the external capacitor for polarization is considered (FIG. 10). During the time τ=RC, the potential difference of the external capacitor is raised to U volts. The migration of ions through the selectively permeable membranes charges the electrodialysis cell in the first section, the difference in dielectric constant modifies this charge by dQ in the second section where the membranes are perfect insulates. The potential difference of the external capacitor is thus reduced to zero. The external field E being thereby removed, only the internal field of accumulated charges Ei remains, equal and opposite in direction to E. The voltage U′ appears at the extremities of the resistive conductor as dU′/dx=E′ and a discharge current develops.

Taking into account the traverse speed of the ionized fluid, high in relation to the migration speed of the ions, the discharge current has an important component in the direction of motion of the ionized fluid but maintains the transverse component due to the existence of the field E′. The excess charges dQ are neutralized. In the third section, where the concentrating, anodic and cathodic chambers are linked, the ionized fluid being more concentrated, the electric resistance of this section is markedly weaker than the electric resistance of the first section. The discharge current is therefore more important there and the discharge time constant is less.

2) Modeling

The device is modeled as represented in FIG. 11. In this schema, the components are represented by their habitual symbols without particular references in order to avoid overloading the diagram. The longitudinal component, in the direction of fluid motion, of the discharge current is modeled by diodes. The first element T1 of this electrodialysis cell corresponds to a voltage generator supplying the plates of a capacitor through a charge impedance. An inverter 16 models the periodic supplying of square wave voltage. The second element T2 corresponds to a capacitor without bleed resistance, whose plates are linked to those of the preceding capacitor by means of resistors and diodes (as the charge-transporting ionized fluid only flows in one direction). The third element T3 corresponds to a weak charge resistance into which flows the output of the electric generator constituting the first element.

The system, fed by periodic square wave voltage, behaves as an ion pump.

3) Consequences

The use of a pulsed voltage, described above, to deionize an ionized fluid, in addition to the periodic discharging of the selectively ion-permeable membranes thereby avoiding the crystallization of certain salts responsible for clogging the membranes and improving the ionic diffusions at that level, encourages the preferential diffusion of divalent cations such as calcium and magnesium, these ions being the first to be absorbed onto the receptor sites of the membranes.

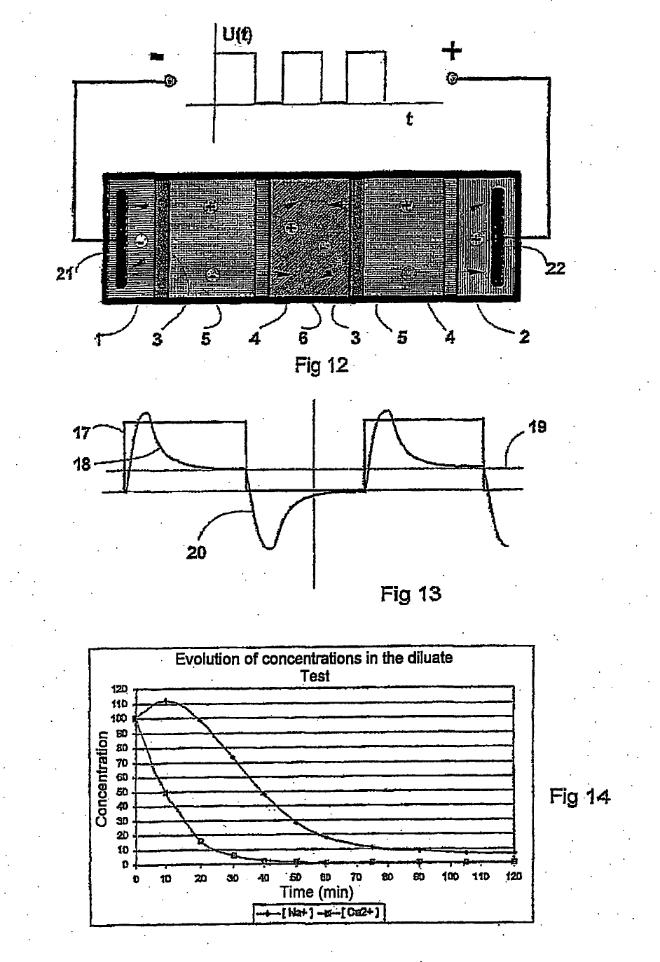

FIG. 12 shows another embodiment mode of an electrodialysis cell whose workings are explained by the timing diagrams of FIG. 13 and the diagram of FIG. 14.

With the simple objective of softening a fluid rich in divalent ions, the invention considers the use of a conventional electrodialysis cell, with electrodes (cathode 21, anode 22) immersed in the cathodic and anodic chambers 1, 2, but supplied with square pulsed voltage U(t). FIG. 13 represents the squared voltage (17) applied to the electrodes 21, 22. The charge current according to the curve (18) of the electrodes 21, 22 is output into the electrodialysis cell. The permanent current of electrodialysis in non-pulsed mode is represented by the curve 19. The discharge current of the electrodes is given by the curve 20.

The elimination of the divalent cations is then time-selective. The divalent cations are eliminated first, followed by the monovalent cations (FIG. 14). The electrodialysis stops as soon as the reduction in the level of divalent cations is sufficient, when softening is the sole objective, or continues until the complete deionization of the ionized fluid.

This embodiment mode replaces a classic softener of the ion exchange resin type. It has the advantage that it does not require any membrane regeneration, does not flush away any brine and only consumes the minimum energy necessary to eliminate the divalent ions. This embodiment mode find applications within all the domains where a conventional softener might be used, but equally in all electrodialysis applications or upstream of reverse osmosis applications where there is a high risk of membrane clogging.

All these devices and embodiment modes concern the deionization of an ionized fluid. Many other non-ionic substances may exist in the fluid and the elimination of such is interesting in order to produce an ultra-pure fluid. The invention considers in this case treatment of the deionized fluid, provided by these devices, by means of reverse osmosis, which takes place under very low pressure.

It is likewise interesting to selectively recover the bases and acids potentially contained in the end chambers of the deionizing cells. For this purpose the invention modifies the structure of the third element, which then possesses four distinct chambers: a concentrated fluid chamber combining all the concentrating chambers of the second element, a partially deionized fluid chamber combining all the deionizing chambers of the second element, a chamber containing the excess cations and a chamber containing the excess anions. These latter two chambers show an electric potential difference, resulting from the presence of excess charges, which is utilizable as a source of electricity by immersing electrodes in these chambers. When these electrodes output a current in any electric circuit linking them, the electrochemical reactions of electrodes are produced, the cathode releasing the electrons to the cations that the anode acquires from the anions. Electrically neutralized, the atoms that formed the ions react with the fluid in order to give the corresponding bases and acids and/or the gases produced by the electrolysis. The end chambers of the following cell are fed with initial ionized fluid or with concentrated fluid stemming from the preceding cell. The embodiment mode finds application principally in the concentration of substances in order to recover the toxic or precious metal ions.

It only remains to compare the efficiency and the technical difficulties of realization (very simple in all the embodiment modes considered) of a magnetodialysis system (using the magnetic component of the Lorentz equation: q*(v×B) which develops a Hall effect voltage of a few millivolts with powerful magnetic fields rotating at several thousand times per second and producing energy losses through the joule effect in the windings and through hysteresis in the ferromagnetic nodes of the inductors, with the ionic pumping electrodialysis system (using the electric component of the Lorentz equation: q*E), thereby developing a periodic potential of several volts, even of tens or hundreds of volts, and without any particular loss of energy.

Softening through classical electrodialysis, but at pulsed voltage, represents by itself a significant innovative improvement in the area of application of conventional electrodialysis and water softening by means of purely physical and consequently non-polluting processes.

1. Device for deionizing an ionized fluid, comprising:
at least one deionizing cell comprising a continuous conduit, the external wall of which is totally impermeable to fluid, electrically insulating and non-ferromagnetic, each cell comprising
a first element provided with an alternating pile of first membranes which are selectively ion-permeable and define concentrating chambers and deionizing chambers and a chamber on each end of the pile,
a second element comprising a pile having a number of second membranes equal to the number of first membranes, the second membranes being electrically insulating and separated by dividers extending the deionizing chambers, the concentrating chambers and the end chambers of the first element,
a the third element provided with two chambers, one of them combining all concentrating chambers and end chambers, the other combining all deionizing chambers (5); and
a Laplace force generator acting on the at least one deionizing cell.

2. Device according to claim 1, that comprises a succession of cells and wherein fluid from the deionizing chambers of one cell is subsequently injected into the deionizing chambers of the first element of the following cell, the concentrated fluid from the one cell being injected into the concentrating chambers and the end chambers of the first element of the following cell.

3. Device according to claim 1, wherein the Laplace force acts upon only the first two elements of at least one said deionizing cell, developing on the ions of the fluid a force not parallel to of the selectively ion-permeable membranes and the electrically insulating membranes and oriented so that the cations pass through the selectively cation-permeable membranes and the anions pass through selectively anion-permeable membranes of the alternating pile of first membranes, the vectors (E and v×B) being in the same direction.

4. Device according to claim 3, wherein
the first two elements of each deionizing cell have a helicoidal form,
the Laplace force (F=q*(E+v×B)) is produced with a zero electric field (E=0), the magnetic induction (B) is mobile and rotates around the axis of the helicoidal form at a velocity higher than the velocity of the ions of the circulating ionized fluid, the motion of the magnetic field (B) being the result of the vectorial combination of dephased alternating fields of the same frequency (f), of which the dephasings and respective orientations in the spatial plane give a field (B) rotating in one direction only at the frequency (f) in this plane, and
the Laplace force generator is external to the cell.

5. Device according to claim 1, wherein the Laplace force (F=q*(E+v×B)) applied to the cell is produced with a zero magnetic induction (B=0), the electric field (E) is generated by two electric conductors external to the cell, periodically raised to a potential difference (U) constant during one part of the period and zero during another part of the period, giving a rectangular signal, the electric field (E) having an orientation so that the force (F=q*E) acting on the ions causes the cations to pass through selectively cation-permeable membranes and the anions to pass through selectively anion-permeable membranes of the alternating pile of first membranes, the generator of the Laplace force being external to the cell.

6. Device according to claim 1, wherein the third element of each cell is provided with four distinct chambers, comprising:
a concentrating chamber combining all the concentrating chambers of the second element,
a deionizing chamber combining all the deionizing chambers of the second element, and
end chambers, one containing a fluid with an excess of cations, the other containing a fluid with an excess of anions, that are recovered and treated separately, and
wherein the end chambers of the first element of following cell receiving the initial ionized fluid or concentrated fluid produced by the preceding cell.

7. Device according to claim 6, wherein the end chambers, one containing fluid with an excess of cations and the other containing fluid with an excess of anions, are placed in an electric relationship by means of electrodes in contact with these fluids, thereby developing an electric voltage that may be used for the generation of electricity and providing the recoverable products of electrolysis corresponding to the ionized fluid used.

8. Device according to claim 1, wherein the first membranes are alternately cation-permeable and anion-permeable, and the Laplace force generator is an external generator of rotating induction (B) in the plane of the membranes, acting on the whole length of the cell by producing on the ions (charge q) of the circulating ionized fluid, at a velocity (V), a force (F=q*(V×B)) so that the cations pass through the cation-permeable membranes and the anions pass through the anion-permeable membranes, thereby developing a Hall effect on the internal wall of the end chambers of the cell, the cell being formed of a helicoidal coil placing into electrical contact a wall carrying one type of ions and another wall carrying the other type of ions, by means of an electroconducting junction, the walls themselves being conductors locally along this junction established along the length of the helicoidal coil, in order thereby to continually discharge the Hall potential, the useful length of the first element of the cell being large in relation to its second and third elements, the time constant (τ) being infinite.

9. Device according to claim 8, wherein the fluid, progressively enriched in electrolysis products in the end chambers of the cell, is recovered at intervals along the cell when the concentration requires it and is replaced by initial ionized fluid or concentrated fluid proceeding from the concentrating chambers upstream of the recovery points.

10. Device according to claim 5, wherein
the end chambers contain electrodes in contact with the ionized fluid, the electric field (E) is generated by two electric conductors internal to the cell, the cathode being inside a said end chamber enclosed by the external wall and a selectively cation-permeable membrane and the anode being inside a said end chamber enclosed by the external wall and a selectively anion-permeable membrane,
the electrodes are supplied by a periodic electric voltage U(t) in the form of a rectangular signal, constant over one part of the period and zero over the other part, and
the useful length of the first element of the cell is thus large in relation to the second and third elements, the time constant τ being infinite.

11. Device according to claim 1, wherein the deionized fluid recovered on exiting the deionizing conduit is treated by reverse osmosis, at low pressure, in order to eliminate non-ionic substances that may also be present in the ionized fluid used and to provide an ultra-pure fluid.

12. Device according to claim 1, wherein the deionizing cell is formed of at least three tubes one within the other, with parallel axes, of which the walls are in non-ferromagnetic substances, wherein the wall of the external tube is impermeable to the fluid to be deionized and electrically insulating, the walls of the internal tubes are each composed of two opposite sections separated at a plane passing through the axis of the internal tube, in a semi-ion-permeable substance, one section being cation-permeable, the other section being anion-permeable, these two sections of wall being linked, and the structures of the two internal tubes are reversed relative to each other.
